(19) United States
(12) Patent Application Publication
(10) Pub. No.: US 2016/0063784 A1
(43) Pub. Date: Mar. 3, 2016

(54) PORTABLE DEVICE FOR SMART ENTRY

(71) Applicant: TOYOTA JIDOSHA KABUSHIKI KAISHA, Toyota-shi, Aichi-ken (JP)

(72) Inventors: Hiroko MURAKAMI, Toyota-shi, Aichi-ken (JP); Akira OGINO, Toyota-shi, Aichi-ken (JP); Tetsuya KOBAYASHI, Kiyosu-shi, Aichi-ken (JP)

(73) Assignee: TOYOTA JIDOSHA KABUSHIKI KAISHA, Toyota-shi, Aichi-ken (JP)

(21) Appl. No.: 14/783,558

(22) PCT Filed: Apr. 8, 2014
(86) PCT No.: PCT/IB2014/000508

§ 371 Date: Oct. 9, 2015

(30) Foreign Application Priority Data
Apr. 11, 2013 (JP) 2013-083156

(51) Int. Cl. G07C 9/00

(52) U.S. Cl. CPC G07C 9/00111

(57) ABSTRACT

A portable device for smart entry for locking and unlocking a door includes an electronic circuit, battery, and a controller. The electronic circuit is configured to perform wireless communication for locking and unlocking the door. The battery is configured to supply electric power to the electronic circuit. The controller configured to control the wireless communication. The controller is configured to shut off conduction of electric current between the battery and the electronic circuit when the controller determines that a remaining capacity of the battery is equal to or lower than a reference value. The controller is configured to resume conduction of electric current between the battery and the electronic circuit when a particular operation on the portable device is detected after the conduction is shut off.

### BACKGROUND OF THE INVENTION

1. Field of the Invention

The invention relates to a portable device for smart entry, which is adapted to lock and unlock a door of a vehicle, or the like.

2. Description of Related Art

Conventionally, an electronic key system that permits locking and unlocking of a door of a vehicle, by performing ID matching through wireless communication between an electronic key carried by the user and a vehicle-mounted device, is used. In the electronic key system, the electronic key needs to be constantly held in a standby state for monitoring radio waves received from the vehicle-mounted device; therefore, power of a battery incorporated in the electronic key is constantly consumed irrespective of whether so-called smart communication, or the like, for ID matching is being conducted.

Therefore, a known example of the electronic key system is arranged to inform the user, via an alarm lamp, or the like, that the remaining battery level of the electronic key is low, when the battery level is reduced. Also, as a method of curbing power consumption of the battery of the electronic key, an electronic key system is proposed which is arranged to supply electric power required to hold the electronic key in the standby state, via radio waves transmitted from a vehicle-mounted device (see, for example, Japanese Patent Application Publication No. 2011-24332 (JP 2011-24332 A).

### SUMMARY OF THE INVENTION

When the remaining battery level of the electronic key is reduced in the known electronic key system, the user is informed of this situation via the alarm lamp, or the like, of the vehicle. However, since the electronic key can be used as usual even after turn-on of the alarm lamp, it may be difficult for the user to recognize the necessity of replacing the battery with a new one. If the user is not informed of the necessity of replacing the battery, the user will continue to use the electronic key without replacing the battery. Finally, the electronic key runs out of battery, and becomes inoperative.

Thus, the known electronic key system is not sufficient to enable the user to surely recognize the necessity of replacing the battery because of the low battery level or charge, after warning about reduction of the remaining battery level of the electronic key.

Also, in the known electronic key, the battery and the electronic circuit are kept connected even when reduction of the battery voltage is detected. Therefore, the battery whose voltage has been reduced is further discharged. As a result, the effect of voltage reduction during the standby period becomes non-negligible.

In the electronic key system as described in JP 2011-24332 A identified above, power consumption of the battery during the standby period can be reduced. However, the system suffers from the following problems. Firstly, there are many restrictions on the location at which the electronic key is placed so that the key can efficiently receive radio waves that provide electric power. Secondly, extensive or significant design additions are needed in hardware and system on the vehicle so that the vehicle can transmit and receive radio waves that provide electric power. Thirdly, the user who does not frequently get in the vehicle has a small chance of having the user's key receive radio waves that provide electric power.

The invention provides a portable device for smart entry, which can eliminate or reduce standby power consumption after the voltage of a battery is reduced, and enable the user to recognize the necessity of replacing the battery with higher certainty.

A portable device for smart entry, the portable device configured to lock and unlock a door, according to one aspect of the invention, includes an electronic circuit, a battery, and a controller. The electronic circuit is configured to perform wireless communication for locking and unlocking the door. The battery is configured to supply electric power to the electronic circuit. The controller is configured to control the wireless communication. The controller is configured to shut off conduction of electric current between the battery and the electronic circuit when the controller determines that a remaining capacity of the battery is equal to or lower than a reference value. The controller is configured to resume conduction of electric current between the battery and the electronic circuit when a particular operation on the portable device is detected after the conduction of the electric current is shut off.

With the above arrangement, after the remaining capacity of the battery becomes equal to or lower than the reference value, conduction of electric current between the battery and the electronic circuit is shut off, except when the particular operation is detected. Therefore, power consumption in the electronic circuit when it is in the standby state can be eliminated. This contributes to prolonging the life of the battery.

Also, the user needs to perform a particular operation when unlocking the door, for example, through wireless communication with the electronic circuit, after the remaining capacity of the battery becomes equal to or smaller than the reference value. Thus, the portable device for smart entry can make the user recognize the weak battery (or low battery level) and the necessity of replacing the battery, with higher certainty.

The portable device for smart entry according to the above aspect of the invention may further include an information provider. The controller may be configured to cause the information provider to provide information that prompts replacement of the battery when the controller determines that the remaining capacity of the battery is equal to or lower than the reference value and when the controller determines that the battery has not been replaced after the conduction of electric current between the battery and the electronic circuit is resumed.

With the above arrangement, the portable device for smart entry provides information that prompts the user to replace the battery when the remaining capacity of the battery is reduced to be equal to or lower than the reference value, and provides information that prompts replacement of the battery again when the battery has not been replaced after the battery and the electronic circuit are connected. It is thus possible to make the user even more strongly aware of the necessity of replacing the battery.

The portable device for smart entry according to the above aspect of the invention may further include a voltage booster configured to increase a voltage of the battery applied to the electronic circuit when the controller resumes conduction of electric current between the battery and the electronic circuit.

With the above arrangement, even when the battery has not been replaced by a new one when conduction of electric current between the battery and the electronic circuit is resumed, the battery voltage applied to the electronic circuit can be increased, so that the life of the battery until the smart-entry portable device becomes completely inoperative can be further prolonged.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the configuration of a smart entry system that uses an electronic key as a portable device for smart entry according to one embodiment of the invention;

FIG. 2A is a view useful for explaining an emergency button and a mechanical key of the electronic key shown in FIG. 1, which view shows a condition in which the mechanical key is pulled out of a recess for storage;

FIG. 2B is a view useful for explaining the emergency button and mechanical key of the electronic key shown in FIG. 1, which view shows a condition in which the mechanical key is stored in the recess;

FIG. 3A is a view useful for explaining a smart communication region in the smart entry system shown in FIG. 1, which view shows a transmission region of a request signal transmitted via a vehicle-exterior antenna;

FIG. 3B is a view useful for explaining a smart communication region in the smart entry system shown in FIG. 1, which view shows a transmission region of a request signal transmitted via a vehicle-interior antenna;

FIG. 4A is a view useful for explaining locking and unlocking of a vehicle door in the smart entry system shown in FIG. 1, which view shows a smart entry function when the battery is in a normal condition;

FIG. 4B is a view useful for explaining locking and unlocking of a vehicle door in the smart entry system shown in FIG. 1, which view shows a smart entry function when the battery is in a low-voltage condition;

FIG. 5 is a flowchart illustrating one example of process performed by an ECU in the electronic key shown in FIG. 1 for prompting battery replacement because of reduction of the battery voltage;

FIG. 6 is a circuit diagram showing the configuration of a principal part of an electronic key as a portable device for smart entry according to another embodiment of the invention; and

FIG. 7 is a circuit diagram showing the configuration of a principal part of an electronic key as a portable device for smart entry according to a further embodiment of the invention.

### DETAILED DESCRIPTION OF EMBODIMENTS

A portable device for smart entry according to one embodiment of the invention will be described with reference to the drawings. In the following, the case where the portable device for smart entry according to the invention is applied to or used for a vehicle (which will be hereinafter called “own vehicle”), such as a hybrid vehicle or an electric vehicle, will be described.

Initially, the configuration of the smart-entry portable device according to this embodiment will be described.

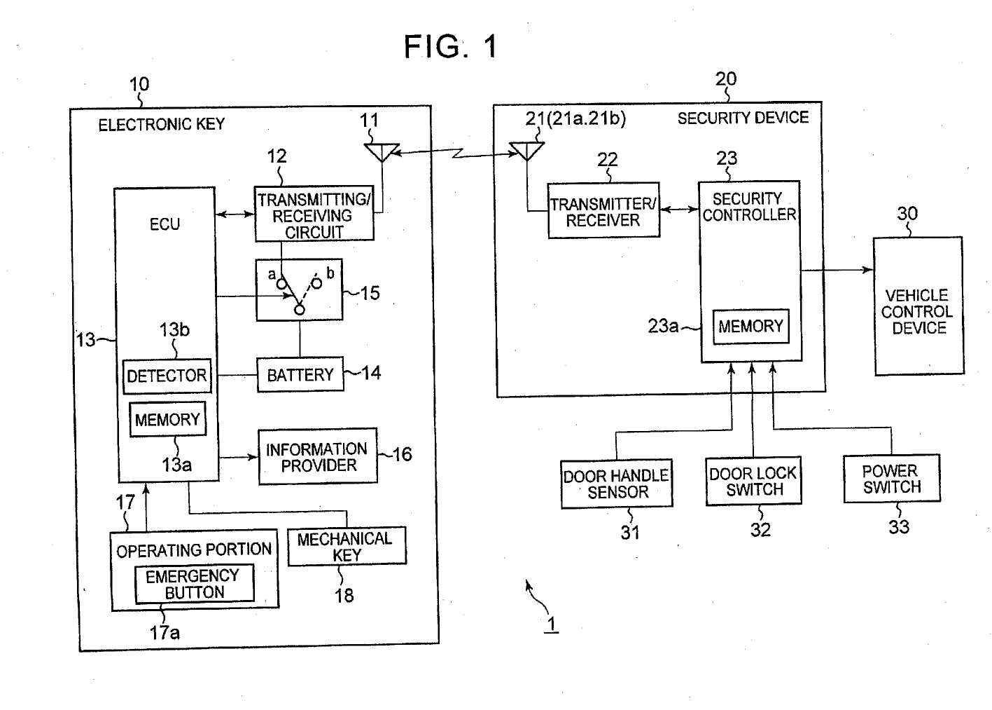

As shown in FIG. 1, an electronic key 10 according to this embodiment, and a security device 20 and a vehicle control device 30 as vehicle-mounted devices installed on the own vehicle, constitute a smart entry system 1. The user of the own vehicle carries the electronic key 10, and the electronic key 10 can communicate with the security device 20 installed on the own vehicle.

The electronic key 10 is used for locking and unlocking a door or doors of the own vehicle, and also used for starting and stopping an engine of the own vehicle. Accordingly, the electronic key 10 provides the portable device for smart entry according to the invention.

The electronic key 10 as the portable device for smart entry includes a transmitting/receiving circuit 12, a battery 14, an ECU 13, an information provider 16, and a voltage booster. The transmitting/receiving circuit 12 is configured as an electronic circuit used for performing wireless communication for locking and unlocking the door. The battery 4 supplies electric power to the transmitting/receiving circuit 12. The ECU 13 serving as a controller controls wireless communication. The voltage booster consists of a battery 14a and a battery 14b connected in series, for example, as will be described later.

The ECU 13 shuts off conduction of electric current between the battery 14 and the transmitting/receiving circuit 12 when it detects that the remaining capacity or charge of the battery 14 is equal to or smaller than a reference value, and resumes conduction of electric current between the battery 14 and the transmitting/receiving circuit 12 only when it detects a particular operation performed on the electronic key 10.

When the ECU 13 detects that the remaining capacity of the battery 14 is equal to or smaller than the reference value, and when it determines that the battery has not been replaced with a new one after the conduction of electric current between the battery 14 and the transmitting/receiving circuit 12 is resumed, the ECU 13 causes the information provider 16 to provide information that prompts the user to replace the battery.

When the conduction of electric current between the battery 14 and the transmitting/receiving circuit 12 is resumed, the ECU 13 causes the voltage booster to increase the battery voltage applied to the transmitting/receiving circuit 12.

The smart entry system 1 will be further described in detail. In the smart entry system 1, the security device 20 installed on the own vehicle receives a signal transmitted from the electronic key 10, and generates a command to the vehicle control device 30 of the own vehicle. The vehicle control device 30 is configured to control locking and unlocking of power door-locks provided in the own vehicle, and also control starting and stopping of the engine, according to the command from the security device 20.

As shown in FIG. 1, the electronic key 10 includes an antenna 11, transmitting/receiving circuit 12, ECU (Electronic Control Unit) 13, battery 14, switch 15, information provider 16, operating portion 17, and a mechanical key 18.

The antenna 11 is a medium for receiving a request signal transmitted from the security device 20, and transmitting an ID-code signal generated from the transmitting/receiving circuit 12, to the security device 20.

The transmitting/receiving circuit 12 is an electronic circuit for performing communication between the electronic key 10 and the security device 20 via the antenna 11. More specifically, the transmitting/receiving circuit 12 receives a request signal transmitted from the security device 20 via the antenna 11. Then, the transmitting/receiving circuit 12 produces a received signal by demodulating the received request signal, and outputs the received signal to the ECU 13.

Also, the transmitting/receiving circuit 12 demodulates an ID-code signal received from the ECU 13, into a signal having a given frequency (e.g., 300 MHz). Then, the transmitting/receiving circuit 12 transmits the demodulated ID-code signal to the security device 20 via the antenna 11.

The request signal and ID-code signal transmitted and received between the transmitting/receiving circuit 12 and the security device 20 are used for locking and unlocking a door or doors, as will be described later. Thus, the transmitting/receiving circuit 12 provides the electronic circuit used for performing wireless communication for locking and unlocking the door according to the invention.

The ECU 13 is comprised of a microprocessor including CPU (Central Processing Unit), ROM (Read-Only Memory), RAM (Random Access Memory) and input and output interfaces, which are not shown in FIG. 1, and a non-volatile memory 13a and a detector 13b.

The ROM of the ECU 13 stores programs that cause the microprocessor to function as the ECU 13. Namely, the CPU of the ECU 13 executes the programs stored in the ROM, using the RAM as a work area, so that the microprocessor functions as the ECU 13. The programs stored in the ROM of the ECU 13 includes a program that specifies a process for prompting the user to replace the battery with a new one because of reduction of the battery voltage as will be described later.

An ID code that is set individually for the electronic key 10 is stored in the memory 13a of the ECU 13. When the ECU 13 receives the received signal derived from the above-mentioned request signal, from the transmitting/receiving circuit 12, the ECU 13 reads the ID code from the memory 13a, and produces an ID-code signal including the ID code. Then, the ECU 13 outputs the ID code to the transmitting/receiving circuit 12, in response to the request signal.

Thus, the ECU 13 controls the transmitting/receiving circuit 12 used for performing wireless communication for locking and unlocking the door. Thus, the ECU 13 provides the controller that controls wireless communication according to the invention.

The detector 13b of the ECU 13 is adapted to detect the voltage of the battery 14. During a period in which communication is performed between the electronic key 10 and the security device 20, the ECU 13 monitors or checks if the battery voltage detected via the detector 13b has been reduced to be equal to or lower than a reference level. More specifically, the ECU 13 determines that the battery voltage is in a normal condition when the battery voltage exceeds the reference level, and determines that the battery voltage is in a low-voltage condition when the battery voltage is equal to or lower than the reference level.

The reference level mentioned herein refers to a voltage level that is high enough to operate the transmitting/receiving circuit 12 in the electronic key 10, but is not sufficient to enable the electronic key 10 to reliably accomplish the functions to be essentially fulfilled in the smart entry system 1. For example, the reference level refers to a voltage level at which a door of a vehicle cannot be unlocked unless an operation required to unlock the door is performed on the electronic key 10 two or more times, though the door can be normally unlocked with certainty by performing the operation only once, for example.

Thus, even if the battery 14 is brought into a low-voltage condition, it does not instantly becomes impossible to lock and unlock the door of the own vehicle through communication with the security device 20, but the door can be locked and unlocked for a while, i.e., during a period in which the user is prompted to replace the battery with a new one. In view of this point, the above-indicated reference level is set to a level higher than the minimum operating voltage of the electronic key 10.

The battery 14 is a power supply from which electric power is supplied to the transmitting/receiving circuit 12 and the ECU 13. For example, the battery 14 is a primary battery, such as a button-shaped battery. The battery 14 is able to supply electric power to the transmitting/receiving circuit 12 via the switch 15.

The switch 15 has a contact a that is electrically connected to the transmitting/receiving circuit 12, and a contact b that is not connected to any circuit. The switch 15 is switched between two positions, i.e., the contact a and the contact b, based on control of the ECU 13, so that the battery 14 and the transmitting/receiving circuit 12 are electrically connected to each other or electrically disconnected from each other.

When the ECU 13 determines that the voltage of the battery 14 is equal to or lower than the reference level, the switch 15 is switched from the contact a to the contact b. As a result, the battery 14 and the transmitting/receiving circuit 12 are electrically disconnected from each other, and discharge of electric power from the battery 14 to the transmitting/receiving circuit 12 is stopped.

The information provider 16 includes, for example, a display device that displays information, such as letters, characters, and symbols, and a speaker that generates voice messages. The information provider 16 visually or auditorily notifies the user of information that prompts the user to replace the battery, under certain conditions as will be described later.

The operating portion 17 includes an emergency button 17a. The emergency button 17a is a button operated by the user for locking and unlocking the vehicle door when the voltage of the battery 14 is in a low-voltage condition.

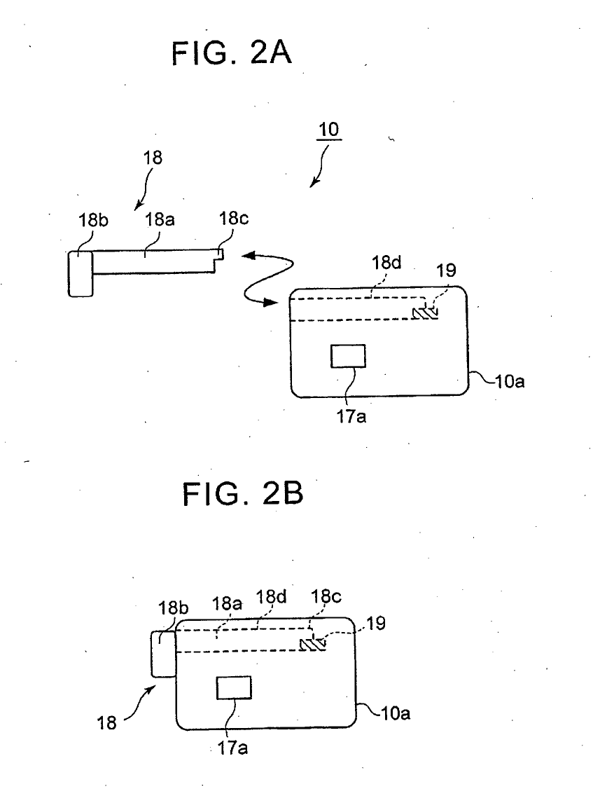

As schematically shown in FIG. 2A and FIG. 2B, the emergency button 17a is provided on a surface of a key main body 10a of the electronic key 10. A normally-off type electric contact (not shown), for example, is provided within the key main body 10a of the electronic key 10, such that the contact is in contact with the emergency button 17a.

In this embodiment, when the user pushes the emergency button 17a, the normally-off type electric contact is placed in an ON state, and an ON signal of the electric contact is transmitted to the ECU 13. Accordingly, the ECU 13 is configured to detect an operation to push the emergency button 17a.

In case of emergency, the mechanical key 18 is inserted into a cylinder lock of the own vehicle and used for locking and unlocking the door. The case of emergency means a condition in which the smart entry function is disabled due to run-out of the battery of the electronic key 10, for example, and the door cannot be locked and unlocked via wireless communication by use of the electronic key 10.

As shown in FIG. 2A and FIG. 2B, the mechanical key 18 includes a key plate portion 18a and a grip portion 18b, and is detachably housed within the key main body 10a of the electronic key 10. The key plate portion 18a is made of a metal, or the like, and has key grooves or spline designed for locking and unlocking the door when inserted into the cylinder lock of the own vehicle. The grip portion 18b, which is provided at the rear end of the key plate portion 18a, is gripped by the user when he/she uses the mechanical key 18.

As shown in FIG. 2A and FIG. 2B, a distal end portion of the key plate portion 18a is formed as a stepped, protruding portion 18c that protrudes in a stepped fashion. In the interior of the key main body 10a of the electronic key 10, a switch 19 is provided in a portion located at an end portion of a recess 18d that receives the mechanical key 18, and the switch 19 is provided with an electric contact (not shown) such that the contact can contact with the switch 19.

As shown in FIG. 2B, when the key plate portion 18a of the mechanical key 18 is inserted into the recess 18d in a given direction, the protruding portion 18c of the key 18 is brought into contact with the switch 19, and pushed in while sliding the switch 19 in the right direction as viewed in FIG. 2B. On the other hand, when the mechanical key 18 is pulled out, the switch 9 slides in the left direction.

When the user pulls out the mechanical key 18, as shown in FIG. 2A, the above-mentioned electric contact comes into the switch 19 that has slid, and a signal of the electric contact is transmitted to the ECU 13. Thus, the ECU 13 is configured to detect the operation to pull out the mechanical key 18.

The security device 20 includes an antenna 21, a transmitter/receiver 22, and a security controller 23. In this embodiment, the security controller 23 mainly performs security control in connection with electric key authentication as will be described later.

The antenna 21 serves both functions of transmitting and receiving, and has vehicle exterior antennas 21a, and vehicle interior antennas 21b. The antenna 21 is a medium for receiving the ID code signal transmitted from the electronic key 10, and transmitting the request signal generated from the transmitter/receiver 22, to the electronic key 10.

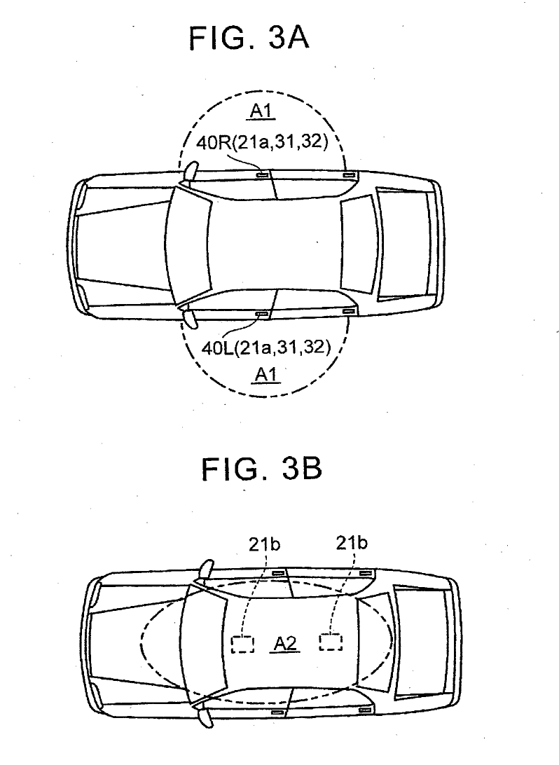

As shown in FIG. 3A, the vehicle exterior antennas 21a that constitute the antenna 21 are incorporated in door handles 40R, 40L on the right and left front sides, respectively. The request signal transmitted from each of the vehicle exterior antennas 21a is transmitted, outside the vehicle, within a range of a given radius (e.g., 1 m) of a circle whose center lies on a corresponding one of the door handles 40R, 40L. In FIG. 3A, transmission regions of the request signal are indicated by two-dot chain lines, as vehicle exterior smart communication regions A1.

The smart entry system 1 according to this embodiment permits two-way or bidirectional communication between the electronic key 10 and the security device 20 within the vehicle exterior smart communication regions A1. Namely, when the electronic key 10 is brought into one of the vehicle exterior smart communication regions A1, in a condition where a request signal is transmitted in the vehicle exterior smart communication region A1, the electronic key 10 receives the request signal, and an ID code signal is transmitted from the electronic key 10.

Referring back to FIG. 1, the transmitter/receiver 22 receives the ID code signal transmitted from the electronic key 10, via the antenna 21, produces a received signal by demodulating the received ID code signal, and outputs the received signal to the security controller 23.

Also, the transmitter/receiver 22 modulates the request signal received from the security controller 23, into a signal having a given frequency (e.g., 134 kHz), and transmits the modulated request signal to the electronic key 10 via the antenna 21.

The security controller 23 includes a non-volatile memory 23a. The memory 23a stores a reference 1D code that is identical with the ID code of the certified electronic key 10 that matches the own vehicle on which the security device 20 is installed.

The security controller 23 generates a request signal to the transmitter/receiver 22, in a condition where the door is locked, so as to monitor the user as the holder of the certified electronic key 10 approaching the own vehicle for boarding (namely, entry into the vehicle exterior smart communication region A1). Namely, the security controller 23 performs first vehicle exterior smart communication control. As a result, the request signal is transmitted from the vehicle exterior antenna 21a to within the vehicle exterior smart communication region A1.

When the security controller 23 receives the received signal associated with the ID code signal from the transmitter/receiver 22, through execution of the first vehicle exterior smart communication control, the controller 23 carries out ID code matching to determine whether the ID code included in the received signal coincides with the above-indicated reference ID code. Then, when the security controller 23 determines, through the ID code matching, that the received ID code coincides with the reference ID code, the controller 23 recognizes that the certified electronic key 10 exists within the vehicle exterior smart communication region A1.

Further, when the security controller 23 detects a touching operation (i.e., the user's touch) on the door handle 40R, 40L, via a door handle sensor 31 incorporated in the door handle 40R, 40L as shown in FIG. 3A, while recognizing the existence of the certified electronic key 10, the controller 23 recognizes an intention of the user as the holder of the certified electronic key 10 to get in the vehicle, and therefore, unlocks the door. In this manner, the user as the holder of the electronic key 10 is permitted to get in the vehicle.

Also, in order to monitor the user as the holder of the certified electronic key 10 being close to the own vehicle when he/she gets out of the vehicle (namely, entry into the vehicle exterior smart communication region A1), the security controller 23 generates a request signal to the transmitter/receiver 22 when a door lock switch 32 provided in each of the door handles 40R, 40L as shown in FIG. 3A is operated by the user. Namely, the security controller 23 performs second vehicle exterior smart communication control. As a result, the request signal is transmitted from the vehicle exterior antenna 21a to within the vehicle exterior smart communication region A1.

When the security controller 23 receives the received signal associated with the ID code signal from the transmitter/receiver 22, through execution of the second vehicle exterior smart communication control, the controller 23 carries out ID code matching to determine whether the ID code included in the received signal coincides with the above-indicated reference ID code. Then, when the security controller 23 determines, through the ID code matching, that the received ID code coincides with the reference ID code, the controller 23 recognizes that the certified electronic key 10 exists within the vehicle exterior smart communication region A1. In this case, the security controller 23 locks the door since it recognizes an intention of the user as the holder of the certified electronic key 10 to get out of the vehicle.

Thus, the smart entry system 1 according to this embodiment is provided with the smart entry function of locking and unlocking the door under a condition that a certain operation is performed by the user, when it is determined, through electric key authentication, that the certified electronic key 10 exists within the vehicle exterior smart communication region A1.

Also, in the smart entry system 1 according to this embodiment, the vehicle interior antennas 21b that constitute the antenna 21 included in the security device 20 are provided at appropriate locations (e.g., ceiling portions in the vicinity of front and rear seats) of the vehicle interior, as shown in FIG. 3B. Request signals transmitted from these vehicle interior antennas 21b propagate through substantially the entire region of the vehicle interior, but hardly extend to the outside of the vehicle. In FIG. 3B, a transmission region of the request signal is indicated by a two-dot chain line as a vehicle interior smart communication region A2.

The smart entry system 1 according to this embodiment also permits bidirectional communication between the electronic key 10 and the security device 20 within the vehicle interior smart communication region A2. Namely, when the electronic key 10 is brought into the vehicle interior smart communication region A2, in a condition where a request signal is transmitted within the vehicle interior smart communication region A2, the electronic key 10 receives the request signal, and an ID code signal is transmitted from the electronic key 10.

In order to monitor the user as the holder of the certified electronic key 10 getting in the vehicle (namely, entry into the vehicle interior smart communication region A2), the security controller 23 generates a request signal to the transmitter/receiver 22, under conditions that unlocking of the door was detected, and that locking of the door was subsequently detected. Namely, the security controller 23 performs vehicle interior smart communication control. As a result, the request signal is transmitted from the vehicle interior antennas 21b to within the vehicle interior smart communication region A2.

When the security controller 23 receives the received signal associated with the ID code signal from the transmitter/receiver 22, through execution of the vehicle interior smart communication control, the controller 23 carries out ID code matching to determine whether the ID code included in the received signal coincides with the above-indicated reference ID code. Then, if the security controller 23 determines, through the ID code matching, that the received ID code coincides with the reference ID code, the controller 23 recognizes that the certified electronic key 10 exists within the vehicle interior smart communication region A2.

Further, when a power switch 33 is operated by the user, in a condition where the existence of the certified electronic key 10 in the vehicle interior smart communication region A2 is recognized, the security controller 23 starts the engine, under a condition that a braking operation is performed.

Thus, the smart entry system 1 according to this embodiment is also provided with a so-called one-push-type smart ignition function, namely, a function of starting the engine under a condition that the power switch 33 is pushed or operated, when it is determined, through electric key authentication, that the certified electronic key 10 exists within the vehicle interior smart communication region A2.

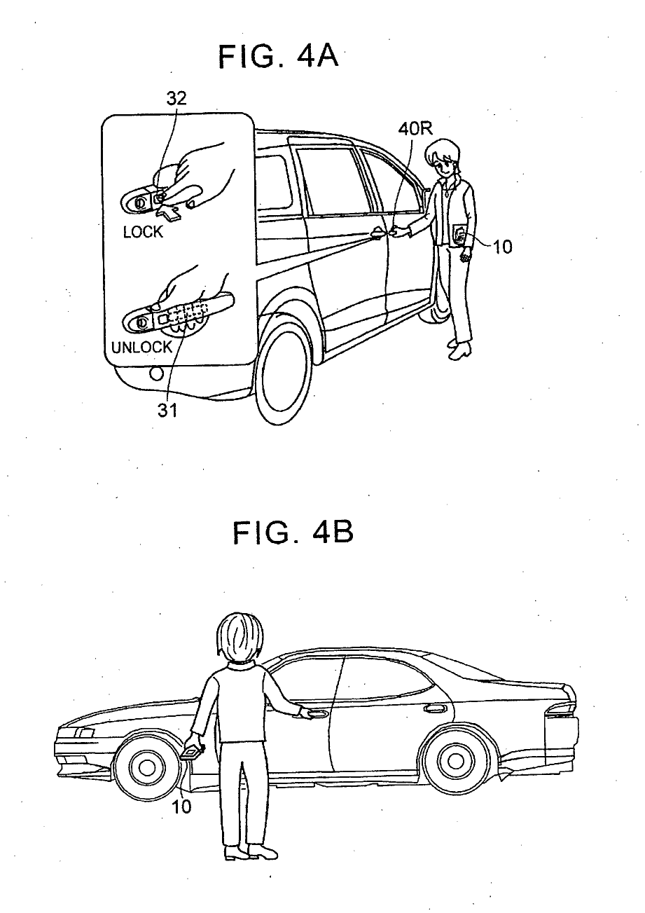

FIG. 4A and FIG. 4B schematically illustrate the smart entry function of locking and unlocking the door under a condition that a certain operation is performed by the user as described above. FIG. 4A illustrates the smart entry function when the battery 14 incorporated in the electronic key 10 is in a normal condition, and FIG. 4B illustrates the smart entry function when the battery 14 is in a low-voltage condition.

When the battery 14 is in the normal condition, the door of the own vehicle is unlocked if the user grips the door handle 40R, in a condition where the electronic key 10 is put in a pocket, for example (namely, a condition where no operation is performed on the electronic key 10), as shown in FIG. 4A.

On the other hand, when the battery 14 is in the low-voltage condition, the door of the own vehicle is unlocked if the user grips the door handle 40R while intentionally performing a particular operation on the electronic key 10, as shown in FIG. 4B. Namely, when the battery 14 is in the low-voltage condition, the smart entry function is enabled only while the particular operation is being performed.

The particular operation mentioned herein means an intentional operation performed in parallel with a direct operation (more specifically, an operation to push the door lock switch 32, or an operation to grip the door handle 40L, 40R so as to cover the area in which the door handle sensor 31 is mounted) performed by the user so as to lock or unlock the door of the own vehicle.

In this embodiment, the particular operation includes an operation to push the emergency button 17a of the operating portion 17, or an operation to pull the mechanical key 18 out of the key main body 10a of the electronic key 10.

In the following, a process performed by the ECU 13 in the electronic key 10 according to this embodiment, for prompting the user to replace the battery with a new one because of reduction of the battery voltage, will be described. The process as described below is implemented according to a program stored in advance in the ROM of the ECU 13, and is executed at given time intervals by the CPU of the ECU 13.

As preconditions, information about the remaining battery level in the electronic key 10 is sent to the security device 20, through communication between the electronic key 10 and the security device 20 as described above, and, when the remaining battery level is reduced, the vehicle control device 30 that receives the information via the security device 20 provides a warning about the reduction of the battery level, using an alarm lamp of the own vehicle, for example.

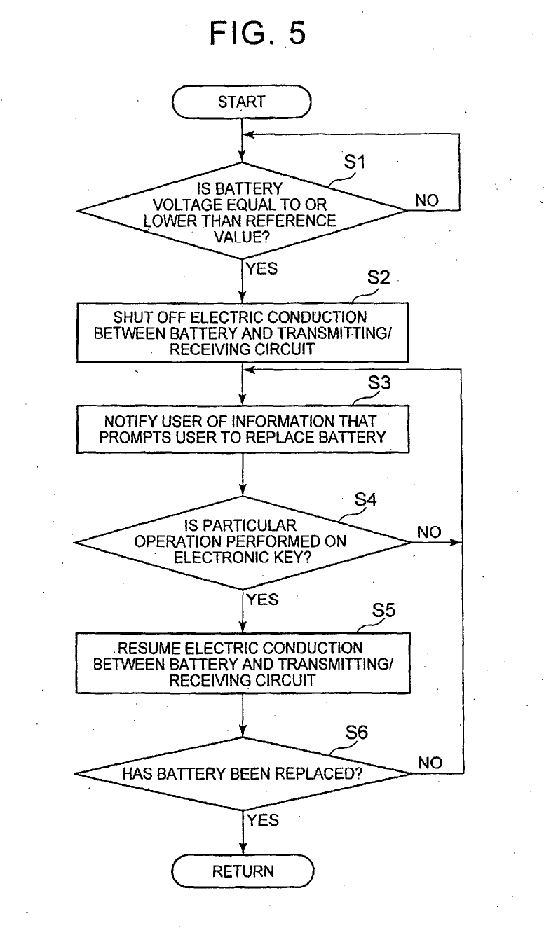

As shown in FIG. 5, the ECU 13 initially determines whether the voltage of the battery 14 has been reduced to be equal to or lower than the reference value (step S1). When the ECU 13 determines that the voltage of the battery 14 has not been reduced to be equal to or lower than the reference value (NO in step S1), step S1 is repeatedly executed until the voltage of the battery 14 is reduced to be equal to or lower than the reference value.

On the other hand, when the ECU 13 determines that the voltage of the battery 14 has been reduced to be equal to or lower than the reference value (YES in step S1), the ECU 13 proceeds to step S2, and shuts off conduction of electric current between the battery 14 and the transmitting/receiving circuit 12 (step S2). Namely, when the voltage of the battery 14 is reduced to be equal to or lower than the reference value, the ECU 13 controls the switch 15 to switch from the contact a to the contact b, so as to cut off electric connection between the battery 14 with the reduced voltage and the transmitting/receiving circuit 12.

Thus, since the battery 14 is electrically disconnected from the transmitting/receiving circuit 12, the battery 14 is prevented from discharging electric current to the transmitting/receiving circuit 12, and no electric power consumption occurs in the transmitting/receiving circuit 12 (i.e., no electric power is consumed by the transmitting/receiving circuit 12. During a period in which no electric power is supplied to the transmitting/receiving circuit 12, the electronic key 10 and the security device 20 cannot communicate with each other, and therefore, the smart entry function is disabled.

During the period in which no electric power is supplied to the transmitting/receiving circuit 12, the information on the remaining battery level in the electronic key 10 is not transmitted to the security device 20, and the warning about reduction of the battery level is not provided in the own vehicle; therefore, the user may not be able to recognize that the battery level is being reduced.

After conduction of electric current between the battery 14 and the transmitting/receiving circuit 12 in the electronic key 10 is shut off, the ECU 13 notifies the user of information that prompts the user to replace the battery with a new one (step S3). For example, if the information provider 16 includes a display device, the ECU 13 causes the display device to display a message that “PLEASE REPLACE BATTERY”. If the information provider 16 includes a speaker, the ECU 13 may prompt the user to replace the battery by use of a voice message, via the speaker.

Thus, the user can recognize that the battery 14 of the electronic key 10 needs to be replaced. Accordingly, the user can replace the battery 14 whose voltage has been reduced, with a new battery, at this point in time, or at an appropriate point in time later than this point.

Next, the ECU 13 determines whether a particular operation on the electronic key 10, namely, an operation to push the emergency button 17a, or an operation to pull out the mechanical key 18, is performed by the user (step S4).

If the ECU 13 determines that the particular operation is not performed (NO in step S4), it returns to step S3 to perform the above-described operation to prompt replacement of the battery, and repeatedly executes step S3 and step S4.

If the ECU 13 determines that the particular operation on the electronic key 10 is performed by the user (YES in step S4), it proceeds to step S5, and resumes conduction of electric current between the battery 14 and the transmitting/receiving circuit 12. Namely, when the particular operation is performed on the electronic key 10, the ECU 13 controls the switch 15 to switch from the contact b to the contact a, so as to electrically connect the battery 14 with the transmitting/receiving circuit 12.

As a result, electric power is supplied from the battery 14 to the transmitting/receiving circuit 12, so that the electronic key 10 and the security device 20 can communicate with each other, and the smart entry function is enabled.

Then, the ECU 13 determines whether the battery 14 has been replaced with a new one (step S6). More specifically, the ECU 13 determines whether the voltage of the battery 14 detected by the detector 13b immediately after the battery 14 is electrically connected to the transmitting/receiving circuit 12 is equal to or higher than the reference value, so as to determine whether replacement of the battery has already been done at this point, or replacement of the battery has not been done.

If the ECU 13 determines that replacement of the battery has not been done (NO in step S6), it returns to step S3 to perform the above-described operation to prompt battery replacement, and repeatedly executes step S3 through step S6.

If, on the other hand, the ECU 13 determines that replacement of the battery has been done (YES in step S6), it returns to step S1, and repeats this control routine.

As explained above, the electronic key 10 used in the smart entry system 1 according to this embodiment can yield the following effects.

In the electronic key 10 according to this embodiment, conduction of electric current between the battery 14 and the transmitting/receiving circuit 12 is shut off (i.e., no electric current flows between the battery 14 and the transmitting/receiving circuit 12), after the battery 14 is brought into a low-voltage condition and a warning about reduction of the remaining battery level is provided in the own vehicle, except when the user performs a particular operation (i.e., an operation to push the emergency button 17a, or an operation to pull out the mechanical key 18) on the electronic key 10.

As a result, supply of electric power to the transmitting/receiving circuit 12 is interrupted or stopped, so that no electric power is consumed in the transmitting/receiving circuit 12 when the electronic key 10 is in a standby state. Accordingly, the power of the battery 14 having the reduced battery level is less likely or unlikely to be wasted, and the battery 14 can be used for a prolonged period of time.

In this connection, in a conventional electronic key, a battery and a circuit are kept connected even when reduction of the battery voltage is detected; therefore, the battery that is in a low-voltage condition is further discharged, and the amount of electric power consumed while the key is in a standby state is increased. In a button-shaped battery, in particular, its discharge characteristics indicate a rapidly increased discharge as the remaining battery level becomes lower than one half of the full level, and therefore, the electric power consumption is significantly or remarkably increased.

On the other hand, in the electronic key 10 according to this embodiment, after the battery 14 is brought into a low-voltage condition, and a warning about reduction of the remaining battery level is provided, the battery 14 is electrically disconnected from the transmitting/receiving circuit 12 unless as the user intentionally performs a particular operation. Therefore, the life of the battery 14 until the electronic key 10 becomes completely inoperative can be further prolonged.

Also, when the electronic key 10 according to this embodiment is used for unlocking the door, for example, through wireless communication using the transmitting/receiving circuit 12, after the battery 14 is brought into a low-voltage condition and a warning about reduction of the remaining battery level is provided in the own vehicle, the user is required to perform a particular operation on the electronic key 10, as shown in FIG. 4B. Thus, the electronic key 10 of this embodiment can enable the user to recognize the reduction of the battery voltage and the necessity of replacing the battery with improved certainty.

Namely, after the battery 14 is brought into the low-voltage condition and the warning about reduction of the remaining battery level is provided, the electronic key 10 according to this embodiment forces the user to perform a particular operation that deliberately reduces convenience for the user, so as to surely remind the user of the low power level of the battery each time the user uses the own vehicle, and constantly make the user conscious of the necessity of replacing the battery.

Also, the electronic key 10 according to this embodiment is useful when a family, or the like, shares the own vehicle, as described below.

Generally, two or more electronic keys are often registered for a single vehicle, so that two or more persons can share the vehicle. In this case, it is necessary to make a determination with respect to each electronic key in the system, namely, determine which of the electronic keys has its, battery voltage reduced, which makes the system complicated, and also makes the system design complicated.

If the user and one or more passengers have two or more electronic keys, respectively, and the voltage of only one of the electronic keys is at a low level, the system operates unstably, which may induce confusion. As a result, erroneous replacement of system components may take place at the dealer.

In view of the above-described inconvenience, the electronic key 10 according to this embodiment prompts the user to replace the battery with a new one when the battery voltage is reduced, and then urges the user to replace the battery again if replacement of the battery has not been done. Thus, the electronic key 10 makes it possible to avoid a situation where the electronic key 10 becomes inoperative due to reduction of the voltage of the battery 14.

Accordingly, when two or more electronic keys 10 are registered for the own vehicle, it is possible to surely inform the user of which of the electronic keys 10 has its voltage battery reduced, by simply changing the design of each electronic key 10, without changing the design of the smart entry system 1 as a whole.

Thus, it becomes unnecessary to make a determination with respect to each electronic key 10 in the smart entry system 1, so that the system can be simplified. Also, it is possible to avoid a situation where only one of the electronic keys 10 has its battery voltage reduced in the smart entry system 1; therefore, the operation of the system can be stabilized.

In the electronic key 10 as the portable device for smart entry according to the above-described embodiment, the battery 14 and the transmitting/receiving circuit 12 are electrically connected to each other when the user performs a particular operation on the electronic key 10. Namely, the voltage corresponding to the remaining capacity of the battery 14 at the time when the particular operation is performed is applied as it is to the transmitting/receiving circuit 12.

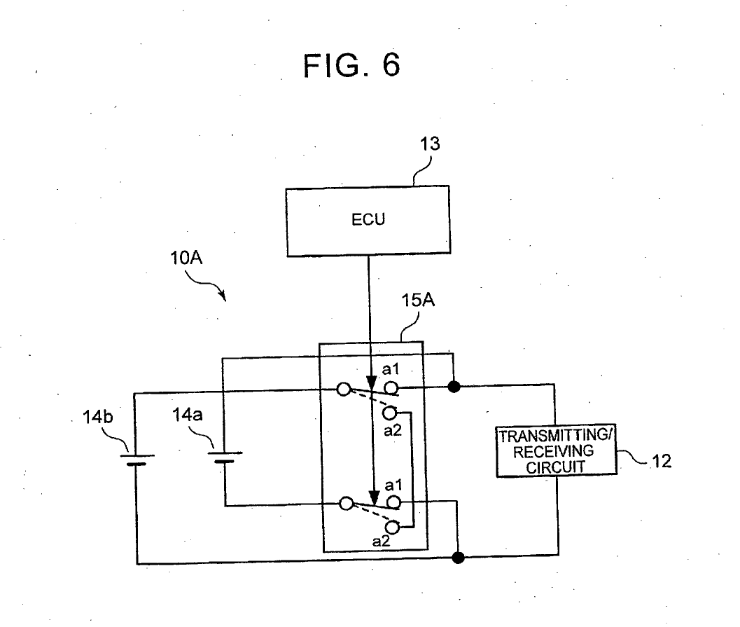

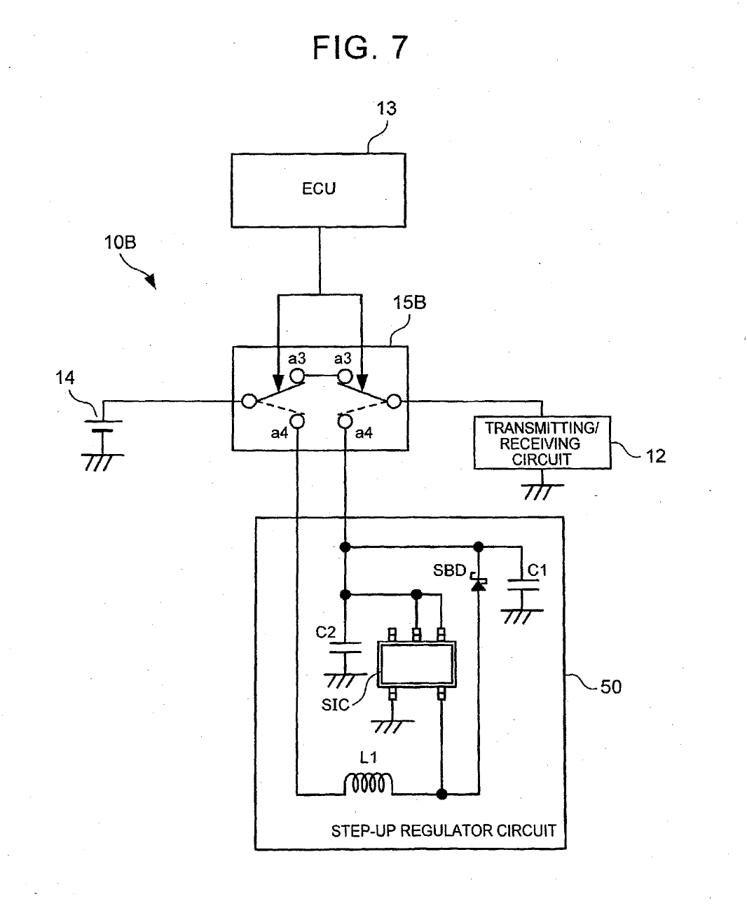

At this time, if the battery 14 has not been replaced with a new one, the electronic key 10 may run out of battery soon, and there is a high possibility that the smart entry system 1 using the electronic key 10 does not function normally. In this case, when the battery voltage is applied to the transmitting/receiving circuit 12 at the time when the particular operation is performed by the user, it is desirable to raise the battery voltage by some means. Embodiments of this case are shown in FIG. 6 and FIG. 7.

FIG. 6 shows the circuit configuration of a principal part of an electronic key 10A as a portable device for smart entry according to another embodiment of the invention. Portions of the configuration of the electronic key 10A in common with those of the configuration of the electronic key 10 according to the above-described embodiment will not be described, and only differences between the electronic key 10A and the electronic key 10 will be described.

As shown in FIG. 6, the electronic key 10A includes two batteries 14a, 14b, and a switch 15A. The battery 14a and the battery 14b have the same capacity and the same battery voltage. The switch 15A is a twin-structure switch consisting of two switch elements that are simultaneously turned on and off, and each switch element includes a contact a1 and a contact a2. Each switch element of the switch 15A is switched between two positions corresponding to the contact a1 and the contact a2, based on control of the ECU 13.

When each switch element of the switch 15A is connected to the contact a1, the two batteries 14a, 14b are connected in parallel, as indicated by solid lines in FIG. 6, and the voltage of each battery 14a, 14b is applied to the transmitting/receiving circuit 12. On the other hand, when each switch element of the switch 15A is connected to the contact a2, the two batteries 14a, 14b are connected in series, as indicated by broken lines in FIG. 6, and the total voltage of the batteries 14a, 14b is applied to the transmitting/receiving circuit 12.

Thus, in the electronic key 10A according to this embodiment, the ECU 13 causes each switch element of the switch 15A to be connected to a selected one of the contact a1 and the contact a2, so that a selected one of the voltage of each of the batteries 14a, 14b connected in parallel, and the total voltage of the batteries 14a, 14b connected in series, is applied as the battery voltage to the transmitting/receiving circuit 12.

Accordingly, when the battery voltage is applied to the transmitting/receiving circuit 12 at the time when the particular operation is performed by the user, each switch element of the switch 15A is switched to the contact a2 so that the battery 14a and the battery 14b are connected in series, whereby the battery voltage applied to the transmitting/receiving circuit 12 can be raised. In this case, the battery 14a and battery 14b connected in series constitute the voltage booster according to the invention.

In the electronic key 10A according to this embodiment, even in the case where replacement of the battery has not been done when conduction of electric current between each battery 14a, 14h and the transmitting/receiving circuit 12 is resumed, the battery voltage applied to the transmitting/receiving circuit 12 can be raised, so that the life of each battery 14A, 14B until the electronic key 10A becomes completely inoperative can be prolonged.

FIG. 7 shows the circuit configuration of a principal part of an electronic key 10B as a portable device for smart entry according to a further embodiment of the invention. Portions of the configuration of the electronic key 10B in common with those of the configuration of the electronic key 10 according to the above-described embodiment will not be described, and only differences between the electronic key 10B and the electronic key 10 will be described.

As shown in FIG. 7, the electronic key 10B includes a step-up regulator circuit 50, and a switch 15B. The switch 15B is a twin-structure switch consisting of two switch elements that are simultaneously turned on and off. Each of the switch elements includes a contact a3 and a contact a4. Each switch element of the switch 15B is switched between two positions corresponding to the contact a3 and the contact a3, based on control of the ECU 13.

When each switch element of the switch 15B is connected to the contact a3, the voltage of the battery 14 is applied to the transmitting/receiving circuit 12 as indicated by solid lines in FIG. 7. On the other hand, when each switch element of the switch 15B is connected to the contact a4, the voltage of the battery 14 is applied to the transmitting/receiving circuit 12 via the step-up regulator circuit 50, as indicated by broken lines in FIG. 7.

Thus, in the electronic key 10B according to this embodiment, the ECU 13 causes each switch element of the switch 15B to be connected to a selected one of the contact a3 and the contact a4, so that a selected one of the voltage of the battery 14 and the voltage raised via the step-up regulator circuit 50 is applied as the battery voltage to the transmitting/receiving circuit 12.

Accordingly, when the battery voltage is applied to the transmitting/receiving circuit 12 at the time when the particular operation is performed by the user, each switch element of the switch 15B is switched to the contact a4 so that the step-up regulator circuit 50 is interposed between the battery 14 and the transmitting/receiving circuit 12. In this manner, the battery voltage applied to the transmitting/receiving circuit 12 can be raised. In this case, the step-up regulator circuit 50 provides the voltage booster according to the invention.

In the electronic key 10B according to this embodiment, even in the case where replacement of the battery has not been done when conduction of electric current between the battery 14 and the transmitting/receiving circuit 12 is resumed, the battery voltage applied to the transmitting/receiving circuit 12 can be raised via the step-up regulator circuit 50, so that the life of the battery 14 until the electronic key 10B becomes completely inoperative can be prolonged.

In each of the above-described embodiments, the information provider 16 for notifying the user of information that prompts the user to replace the battery is provided in the electronic key 10, 10A, 10B. However, the information provider 16 may be provided in the own vehicle. In this case, the configuration of the smart entry system using the electronic key is substantially identical with the configuration according to each of the above-indicated embodiments, except for the location of the information provider 16, and therefore, will not be particularly illustrated. In the following, only differences will be described.

For example, the information provider 16 is connected to the security controller 23 within the security device 20. In the process flow shown in FIG. 5, when the ECU 13 determines that the battery voltage has been reduced to be equal to or lower than the reference value (YES in step S1), the ECU 13 transmits information that indicates the reduction of the battery voltage, to the security device 20, via the transmitting/receiving circuit 12 and the antenna 11, before conduction of electric current between the battery 14 and the transmitting/receiving circuit 12 is shut off.

In the security device 20, the security controller 23 receives the information indicating the reduction of the battery voltage, via the antenna 21 and the transmitter/receiver 22, and notifies the user of information that prompts the user to replace the battery, via the information provider 16 (step S3 in FIG. 5).

On the other hand, in the electronic key 10, the ECU 13 shuts off conduction of electric current between the battery 14 and the transmitting/receiving circuit 12, after transmitting the information indicating the reduction of the battery voltage to the security device 20 (step S2 in FIG. 5). Then, if the ECU 13 determines that no particular operation is performed on the electronic key 10 (NO in step S4), it repeatedly executes step S4 until a particular operation is performed.

When the ECU 13 determines that the battery has not been replaced with a new one (NO in step S6), after executing step S5, the ECU 13 transmits information that the battery has not been replaced, to the security device 20. In the security device 20, the security controller 23 receives the information that the battery has not been replaced, and notifies the user of information that prompts the user to replace the battery again, via the information provider 16. Thereafter, the above-described process is repeated.

According to the embodiment in which the information provider 16 is provided in the own vehicle, as described above, electric power of the battery 14, 14a, 14b is less likely to be consumed, by an amount of power needed for providing the information, as compared with the embodiments in which the information provider 16 is provided in the electronic key 10.

While the electronic key 10, 10A, 10B is applied to or used in the smart entry system for the vehicle, in each of the above-described embodiments, the invention is not limited to this application, but the smart entry function as described above may be applied to an electronic key system for a building, or the like.

In this case, when the voltage of a battery incorporated in an electronic key for building is reduced to be equal to or lower than a given reference value, the user performs an intentional operation (e.g., an operation on a door knob, or a remote operation using the electronic key) so as to lock or unlock the front door, for example, and the door is locked or unlocked under a condition that the intentional operation is performed.

In each of the above-described embodiments, a primary battery is used as one form of the battery 14, 14a, 14b incorporated in the electronic key 10, 10A, 10B. However, the battery 14, 14a, 14b is not limited to this type, but a rechargeable secondary battery may be used. In this case, in step S3 of the process flow shown in FIG. 5, the ECU 13 may notify the user of information that prompts the user to charge the battery, for example, a message that “PLEASE CHARGE BATTERY”, in place of information that prompts the user to replace the battery.

As described above, the portable device for smart entry according to the invention has an effect of enabling the user to recognize the necessity of replacing the battery with improved certainty, while eliminating or reducing standby power consumption. Thus, the invention is usefully applied to portable devices for smart entry in general, which are adapted to lock and unlock doors of vehicles, or the like.

1. A portable device for smart entry, the portable device configured to lock and unlock a door, the portable device comprising:
an electronic circuit configured to perform wireless communication for locking and unlocking the door;
a battery configured to supply electric power to the electronic circuit;
a controller configured to control the wireless communication, the controller being configured to shut off conduction of electric current between the battery and the electronic circuit when the controller determines that a remaining capacity of the battery is equal to or lower than a reference value, the controller being configured to resume conduction of electric current between the battery and the electronic circuit when a particular operation on the portable device is detected after the conduction of the electric current is shut off.

2. The portable device according to claim 1, further comprising an information provider, wherein
the controller is configured to cause the information provider to provide information that prompts replacement of the battery when the controller determines that the remaining capacity of the battery is equal to or lower than the reference value and when the controller determines that the battery has not been replaced after the conduction of electric current between the battery and the electronic circuit is resumed.

3. The portable device according to claim 1, further comprising a voltage booster configured to increase a voltage of the battery applied to the electronic circuit when the controller resumes the conduction of electric current between the battery and the electronic circuit.

4. The portable device according to claim 2, further comprising a voltage booster configured to increase a voltage of the battery applied to the electronic circuit when the controller resumes the conduction of electric current between the battery and the electronic circuit.
